(19) United States
(12) Patent Application Publication
(10) Pub. No.: US 2007/0189119 A1
(43) Pub. Date: Aug. 16, 2007

(54) System and Method for Measurement While Drilling Telemetry

(75) Inventors: Christian Klotz, Hannover (DE); Hanno Reckmann, Nienhagen (DE); Ingolf Wassermann, Hannover (DE); John D. Macpherson, Sugar Land, TX (US); Jose Alonso Ortiz, Celle (DE); Andrew G. Brooks, Tomball, TX (US)

Correspondence Address: MADAN, MOSSMAN & SRIRAM, P.C., 2603 AUGUSTA, SUITE 700, HOUSTON, TX, 77057, US

(73) Assignee: BAKER HUGHES INCORPORATED, Houston, TX (US)

(21) Appl. No.: 11/674,938

(22) Filed: Feb. 14, 2007

Related U.S. Application Data
(60) Provisional application No. 60/773,024, filed on Feb. 14, 2006.

(51) Int. Cl. H04H 9/00

(52) U.S. Cl. 367/83

(57) ABSTRACT

A system for transmitting information in a well comprises a tubular string disposed in the well and having a drilling fluid flowing therethrough. A pulser is disposed in the tubular string and transmits a pulse synchronization marker comprising a chirp signal. A surface controller, acting under programmed instructions, detects the chirp signal adjusts a signal decoding technique based on the detected chirp signal.

### CROSS-REFERENCES TO RELATED APPLICATIONS

This application claims priority from U.S. provisional patent application Ser. No. 60/773024 filed on Feb. 14, 2006.

### BACKGROUND OF THE INVENTION

1. Field of the Invention

The present invention relates to drilling fluid telemetry systems, and, more particularly, to a system and method for enhancing data transfer.

2. Description of the Related Art

Drilling fluid telemetry systems, generally referred to as mud pulse telemetry systems, are particularly adapted for telemetry of information between the bottom of a borehole and the surface of the earth during oil well drilling operations. The information telemetered often includes, but is not limited to, operational parameters, such as pressure, temperature, direction and deviation of the wellbore. Other parameters include well logging data such as electrical conductivity of the various formation layers, acoustic and nuclear properties, porosity, and pressure gradients related to the reservoirs surrounding the wellbore. This information is useful during the drilling operation and economic production of the reservoirs.

A number of different types of pulser devices (pulsers) which have been utilized to generate pressure pulses in the mud are known to those skilled in the art. Such pulsers include: poppet pulsers for generating positive or negative pressure pulses; siren pulsers for generating continuous wave pulse signals; and rotationally oscillating shear-valve pulsers that may generate discrete pulses and/or continuous wave signals. Various encoding techniques are known in the art for transmitting data utilizing the generated pulse signals. In general, such systems generate a pressure pulse by blocking or venting a portion of the drilling fluid flowing in the drill string to the bit. The generated pulse propagates to the surface where it is detected and decoded for further use.

A number of factors affect the reception and proper decoding of the transmitted information. For example, one source of noise in the detected signal is a result of the large pressure pulses associated with the use of positive displacement, plunger type pumps utilized for pumping the drilling fluid through the system. Such pumps commonly generate pressure pulses one to two orders of magnitude greater than the detected pressure signals at the point of signal detection. In addition, the pump frequency, and/or its harmonics, are commonly within the range of the pulsed signal frequency. Another factor that can affect the reception of the transmitted information at the surface is a change in the drill string wave guide transmission channel during the drilling process. Multiple reflections from the joints in the drill string and from impedance changes along the transmission channel also can cause some frequencies to be substantially attenuated while other frequencies are transmitted with little attenuation. These variations in the transmission path can cause substantial degradation in the received signal, which can cause loss of signal detection, thus resulting in lost time in the drilling operation.

Thus, there is a need for an improved method that enhances signal detection and information transfer reliability.

### SUMMARY OF THE INVENTION

In one aspect of the present invention, a system for transmitting information in a well comprises a tubular string disposed in the well and having a drilling fluid flowing therethrough. In one aspect, a pulser is disposed in the tubular string and transmits a pulse synchronization marker comprising a chirp signal. A surface controller, acting under programmed instructions, detects the chirp signal and adjusts a signal decoding technique based on the detected chirp signal. The surface controller performs the function of noise cancellation in which noise, including at least a portion of the pump noise, is removed. The controller estimates a channel transfer function characterizing the mud channel between the downhole pulser and the surface. Additional steps performed by the controller include an equalization to remove distortion between the processed signal and transmitted signal. The equalizer may be an adaptive linear equalizer, adaptive decision feedback equalizer, or any other suitable equalizer.

In another aspect, a method for transmitting information in a well is provided that includes disposing a pulser in a tubular string in the well. The tubular string has a drilling fluid flowing therethrough. The pulser transmits at least one pulse synchronization marker that may be a chirp signal. The chirp signal is detected at the surface. A decoding technique is adjusted based upon the detected chirp signal. Noise cancellation, including cancellation of pump noise is performed. A channel transfer function characterizing the mud channel between the downhole pulser and the surface is estimated. Additional steps performed by the controller include an equalization step to remove distortion between the processed signal and transmitted signal. The equalization may be performed by a feedback equalizer.

Another embodiment of the invention is a computer readable medium for use with a mud-pulse telemetry apparatus. The apparatus includes a downhole pulser which transmits signals to a surface location through a mud channel. A surface processor receives signals after transmission through the mud channel. The received signal includes noise such as pump noise. The medium includes instructions that enable a processor to cancel the noise, estimate a transfer function of the channel and recover the transmitted signal. The computer readable medium may include ROMs, EPROMs, EAROMs, Flash Memories, hard drives and Optical disks.

Examples of the more important features of the invention thus have been summarized rather broadly in order that the detailed description thereof that follows may be better understood, and in order that the contributions to the art may be appreciated.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals, wherein:

FIG. 1 shows an exemplary drilling system according to one embodiment of the present invention;

FIG. 2 is a flow chart of a drilling fluid telemetry system according to one embodiment of the present invention;

FIG. 3 is a sketch of an exemplary Non-Return to Zero (NRZ) encoding timeline;

FIG. 4 shows an exemplary continuous wave, frequency shift key (FSK) pulse signal and the corresponding NRZ baseband signal;

FIG. 5 shows an exemplary amplitude shift key (ASK) signal and the corresponding NRZ baseband signal;

FIG. 6 shows an exemplary continuous phase modulated (CPM) signal and the corresponding digital bits;

FIG. 7 shows an exemplary dual pressure transducer detection layout;

FIG. 8 shows an exemplary transmission stream comprising synchronization frames and unequal data frames;

FIG. 9 shows details of one embodiment of a synchronization frame;

FIG. 10 shows a representation of a chirp signal as a function of frequency versus time and as a function of amplitude versus time;

FIG. 11 shows an autocorrelation function of a chirp signal in the time domain;

FIG. 12 shows an autocorrelation of a chirp signal in the frequency domain; and

FIG. 13 shows a block diagram of a channel transfer function.

### DETAILED DESCRIPTION OF THE INVENTION

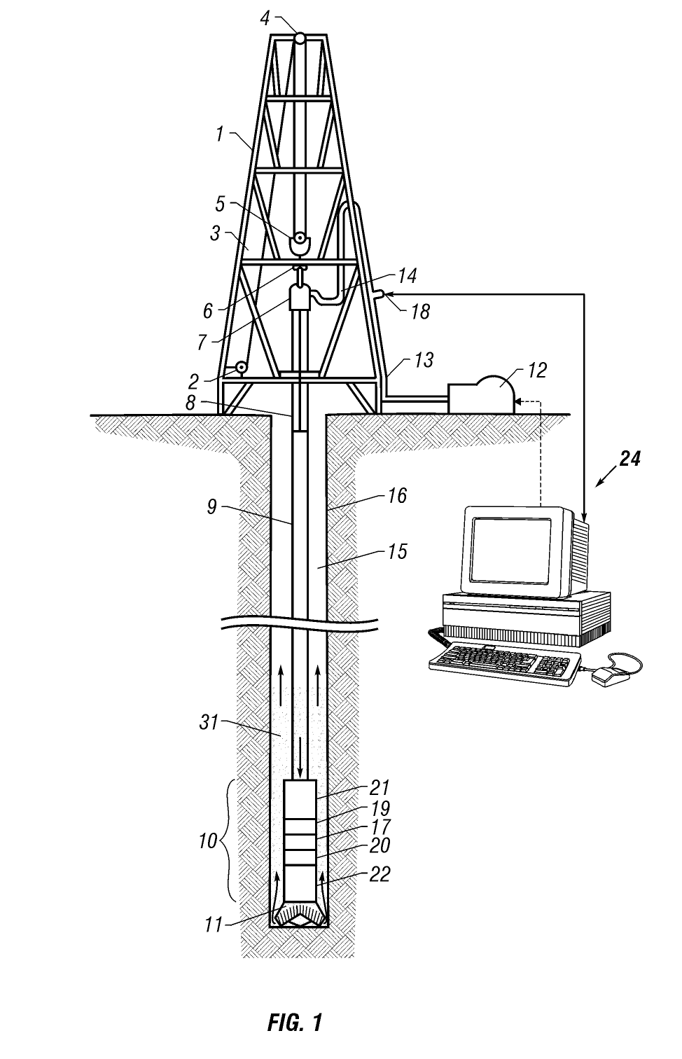

FIG. 1 is a schematic diagram showing a drilling rig 1 engaged in drilling operations. Drilling fluid 31, also called drilling mud, is circulated by pump 12 through the drill string 9 down through the bottom hole assembly (BHA) 10, through the drill bit 11 and back to the surface through the annulus 15 between the drill string 9 and the borehole wall 16. The BHA 10 may comprise any of a number of sensor modules 17, 20, 22 which may include, for example, formation evaluation (FE) sensors, sensors that provide information about operating conditions of the BHA, and survey sensors that provide survey information about the borehole. A partial list of FE sensors may include nuclear sensors, resistivity sensors, acoustic sensors, NMR sensors, etc. A partial list of the operating conditions may include temperature, pressure, rate of penetration, weight on bit, rotational speed, torque, and whirl measurements. Survey sensors may include a magnetometer, an accelerometer, and/or a gyroscope. These sensors are well known in the art and are not described further. The BHA 10 also contains a pulser assembly 19 which induces pressure fluctuations in the mud flow. The pressure fluctuations, or pulses, propagate to the surface through the mud and are detected at the surface by a sensor 18 and a control unit 24. The sensor 18 is connected to the flow line 13 and may comprise at least one of a pressure sensor, a flow sensor, and a combination of a pressure sensor and a flow sensor. As one skilled in the art will appreciate, the pressure pulse has an associated fluid velocity pulse that also propagates through the drilling fluid and may be detected and decoded.

In one embodiment, pulser assembly 19 comprises an oscillating shear valve pulser capable of generating continuous wave pulses. Such a pulser is described in U.S. Pat. No. 6,975,244, issued on Dec. 13, 2005, U.S. Pat. No. 6,626,253, issued on Sep. 30, 2003, and U.S. application Ser. No. 10/422,440, filed on Apr. 24, 2003 and published as US 2004/0012500 on Jan. 22, 2004, each of which is assigned to the assignee of this application, and each of which is incorporated by reference herein. The oscillating shear valve described in these references is capable of generating pulse waveforms of varying frequency, amplitude, phase, and shape, including substantially continuous sinusoidal waves at frequencies of at least 40 Hz. Other types of pursers, such as a poppet type pulser, may also be used.

The downhole pulser 19, also called a transmitter, is only one part of the MWD telemetry system. The complete telemetry system consists of the transmission channel, a surface receiver, and additional surface and downhole processing layers. The surface and downhole components of the system are designed to provide a reliable telemetry system delivering the highest possible bit rate for the particular drilling environment.

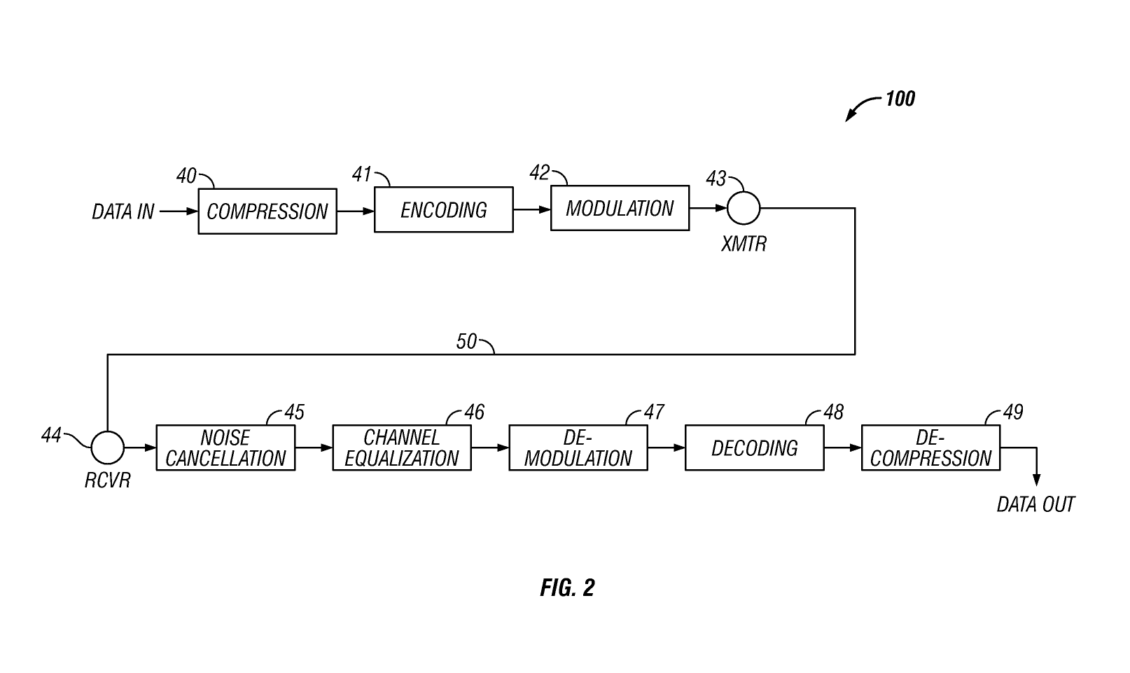

FIG. 2 is a functional block diagram of one embodiment of fluid telemetry system 100. As shown therein, data from sensors 17, 20, 22 (see FIG. 1) are input to pulser 19. Pulser 19 contains circuits and a processor, as described in the incorporated reference documents, for processing and transmitting the data to the surface. In the downhole system the data is compressed. The compression scheme 40 may encompass data scaling and/or any data compression technique known in the art of digital information transmission.

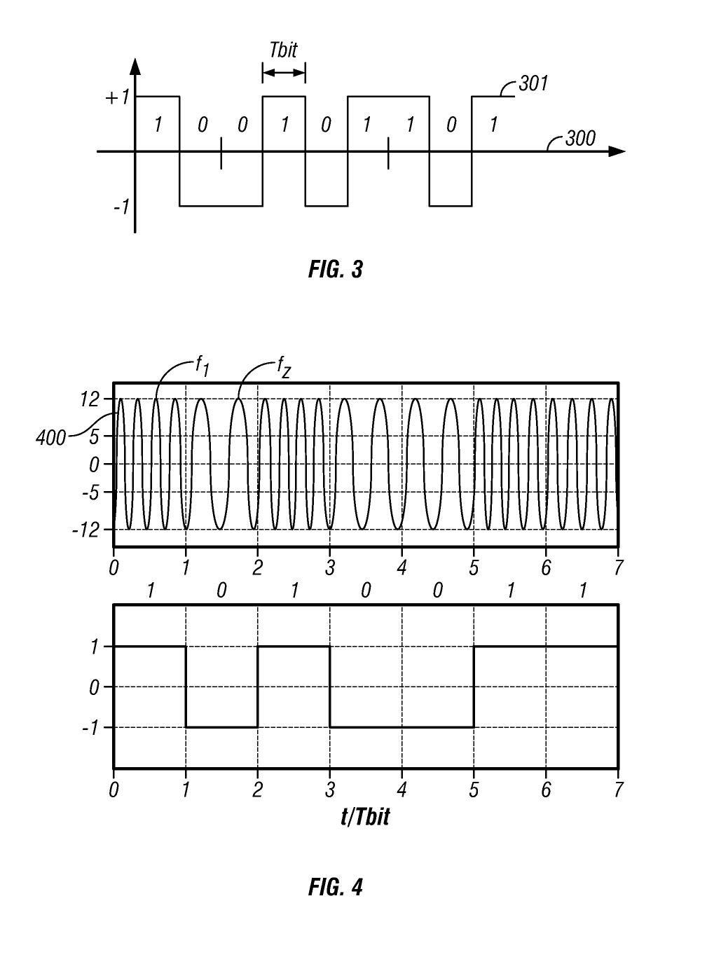

The optionally compressed and error protection encoded binary data is modulated 42. In one embodiment, a non return to zero (NRZ) modulation scheme for baseband transmission is used. In the NRZ scheme, see FIG. 3, the time line is divided into intervals of equal time, each of which is a bit-period, T_{bit}. The signal level is held constant at one of two levels for the duration of the bit-period. For example, a binary 1 may be represented by a level of +1 and a binary zero by a level of −1.

In another embodiment of the present invention the optionally compressed and error protection encoded binary data is modulated 42 using a baseband pulse amplitude modulation (baseband PAM) scheme for transmission. The baseband PAM scheme provides more than two signal levels. Preferably the number of levels M is a power of two so that the number of bits transmitted per symbol can be expressed m=log₂ M. In the PAM scheme the time line is divided into intervals of equal time, each of which is a symbol period where the symbol period equals m bit-periods. The signal level is held constant at one of m levels for the duration of the symbol-period.

As discussed previously, pulser 19 is capable of generating pulse frequencies up to about 40 Hz. This feature allows the use of modulation schemes commonly called passband modulation. Passband modulation encompasses signals on, or centered on, a carrier frequency. Modulation of the carrier frequency is performed to transmit information. Pulser 19 is well suited to transmit such signals. There are four subsets of passband signaling that are of interest: frequency shift keying (FSK), amplitude shift keying (ASK), phase shift keying (PSK) and continuous phase modulation (CPM).

Frequency-Shift-Keying (FSK) is the use of a frequency modulated waveform to carry digital information. In case of binary FSK a first frequency represents a 1, and a second frequency represents a 0. The order of the frequencies is not important, so long as it is known at both the transmitter and receiver locations. An example of such a modulated signal 400 is shown in FIG. 4, where the bitstream pictured in the bottom drawing is modulated. A frequency f₁ represents a 1, and a frequency f₂ represents a 0. Higher level modulation schemes with m different frequencies are possible as well.

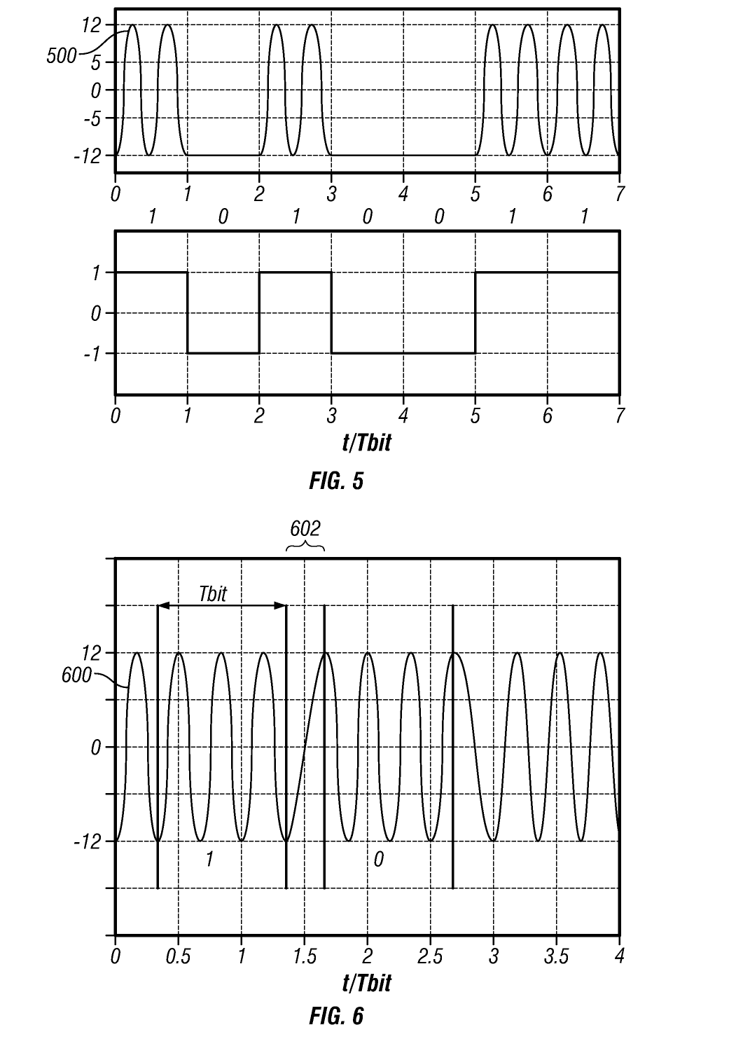

Amplitude-Shift-Keying (ASK) is the use of an amplitude modulated waveform to carry digital information. In ASK a waveform of a single frequency is used to represent a 1 and no signal is sent for a 0. Alternatively, the transform may be inverted so that a 0 is represented with a waveform of known signal, and a 1 with no signal. An example of an ASK signal 500 is shown in FIG. 5, where the bitstream pictured in the bottom drawing of FIG. 5 is ASK modulated. A constant frequency signals to transmit a 1 and no signal represents a 0. Note that the same data word, “1010011”, is transmitted in both FIG. 4 and FIG. 5. Higher level modulation schemes with m amplitude levels of the same frequency are possible as well.

Phase-Shift-Keying (PSK) is the use of a phase modulated waveform to carry digital information. In PSK transmission the frequency is kept constant, and the phase of the signal is changed at bit boundaries. Referring to FIG. 6, for example, with binary PSK (only two states to be represented, 0 or 1), the phase difference is 180°. Because a pulser typically cannot instantaneously change phase, a transition time slot 602 between the pulses will be inserted. This time slot is exactly one period (of the carrier frequency) long. In order to keep the data rate constant over the time, the time slot will be inserted prior to every bit, even when the phase of the carrier frequency 600 does not change at bit edges (binary sequence 11 or 00). In this case the PSK modulator inserts one period of the carrier frequency. When the bit changes from 1 to 0 or from 0 to 1, the modulator inserts half a period of half the carrier frequency to generate the phase change. The insertion of this ‘transition period’ will be done with respect to the phase of the carrier signal at the end of the preceding bit. The beginning of each modulated bit thus depends on the previous bit. This is an example of continuous phase modulation (CPM). Higher level modulation schemes with m phase levels of the same frequency are possible as well.

Once the data are baseband modulated 42, data are passed to transmitter 43, which in one embodiment, is pulser 19.

Referring back to FIG. 2, the encoded and modulated information is transmitted as pressure signals across fluid transmission path 50 and the signals are detected at receiver 44 at or near the surface. Receiver 44 comprises sensor 18 described previously which may be a pressure sensor, a flow sensor, a combination of pressure and flow sensors. Alternatively, a plurality of pressure sensors, flow sensors, or a combination thereof may be used as a sensor array for detecting the pressure signals, as described below. The surface system is basically the inverse of the downhole system, however employing several additional tasks to compensate the measured signal for distortion during transmission. The received signals are treated to remove noise components and distortion using noise cancellation 45 and channel equalization 46 techniques. The data are then demodulated 47, and decoded 48. The data are then decompressed 49, and output to permanent storage and/or further analysis and interpretation as required drilling operations and/or reservoir interpretation.

### Surface Detection Using a Dual Pressure Transducer Technique (DPT)

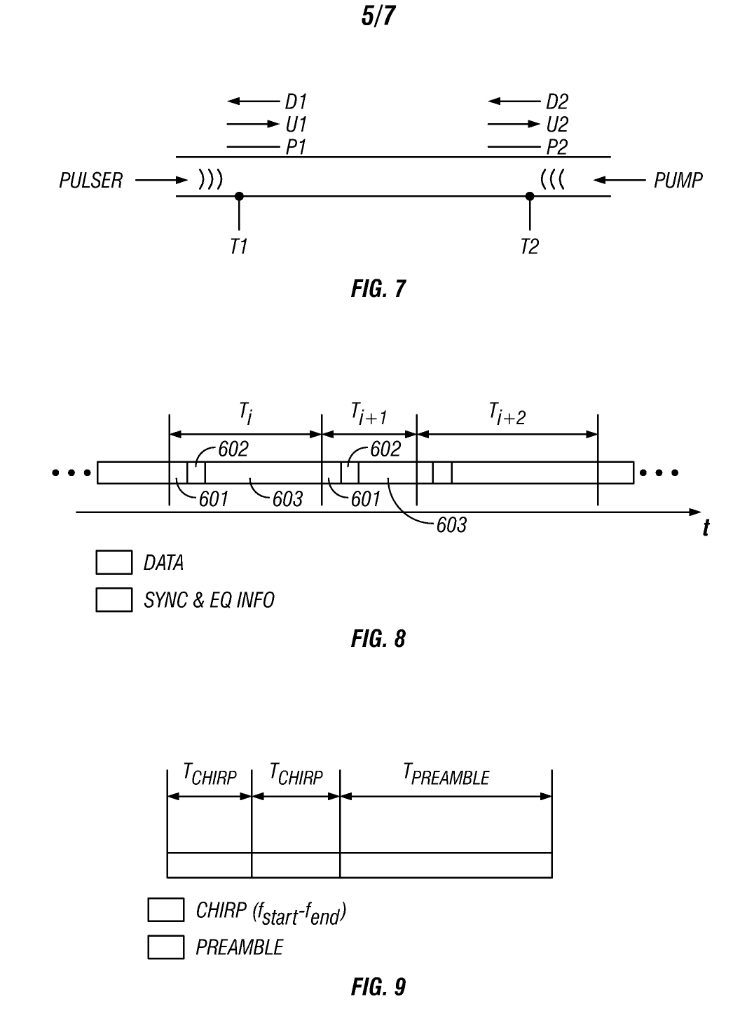

This technique uses data from a pair of longitudinally-spaced transducers, see FIG. 7, at the surface to discriminate between signal components which are traveling upstream (e.g. information from downhole pulser 19) and those traveling downstream (e.g. mud pump noise).

Two input channels correspond to a matched pair of transducers. These may be either pressure transducers, or flow transducers. They should be placed in the same straight pipe section. DPT outputs a single channel containing the component of the signals which is estimated to be traveling upstream.

### DPT Description

Referring to FIG. 7, the outputs from the two transducers are labeled T1 and T2. T2 is from the upstream transducer, closer to the pumps. Each transducer's response contains a steady component P, a down going transient component D, and an up going transient component U. The transducer responses can be written as

T1(t)=P1+D1(t)+U(t) (1),

T2(t)=P2+D2(t)+U2(t) (2).

If there is a signal component traveling downstream from the pumps, it will reach T2 before it reaches T1, with a time delay δt. So the downward component at transducer T2 at time (t−δt), written as D2(t−δt), is the same as the component D1(t) at transducer T1.

Suppose now that we delay the signal from T2 by δt, and subtract it from the signal at T1:

T1(t)−T2(t−δt)=P1+D1(t)+U1(t)−P2−D2(t−δt)−U2(t−δt) (3)

### Substituting D2(t−δt)=D1(t),

T1(t)−T2(t−δt)=P1−P2+U1(t)−U2(t−δt). (4)

### In addition, the up going component takes time δt to travel from T1 to T2, so

U2(t−δt)=U1(t−2δt) (5)

and

T1(t)−T2(t−δt)=P1−P2+U1(t)−U1(t−2δt). (6)

The delay and subtract operation is therefore able to eliminate the down going component, while leaving the up going transient component in the form U1(t)−U1(t−2·δt). By inspection, this is an approximation of the time derivative of the up going component U1, and therefore it should be possible to reconstruct the up going component by time integration. For evenly sampled data, time integration can be accomplished by cumulative summing. However, it is not desirable to integrate the steady component (P2−P1), since this could cause the output to ramp up or down indefinitely. Therefore the transient component is isolated by high pass filtering, before the integration is performed. The steady component of the original signal (i.e., its DC component) can be found by low pass filtering the original transducer outputs. Final output from the technique is the sum of the steady and transient components.

The transducers T1, T2 may be placed in a single uniform straight pipe section to minimize attenuation and reflections. Separation between the transducers may be such that the delay is relatively low, for example, no more than 1/20 second, which corresponds to a maximum spacing of about 50 m. Minimum spacing may be equivalent to about 10 data samples; at a sample rate of 1024 per second this corresponds to about 10 m. Details of the use of the dual-pressure transducer are disclosed in U.S. patent application Ser. Nos. 11/018,344 and 11/311,196 having the same assignee as the present invention and the contents of which are incorporated herein by reference.

### Surface Processing of Detected Signals

Additional techniques are applied to the detected signals to reduce the effects of noise and distortion in the detected signal as compared to the transmitted signal. As discussed previously, pump noise is present in the detected signals and the pump signal may be significantly greater than the desired data signal. In addition, the reflections and transmission characteristics of the drill string transmission channel cause distortion in the data signal as it transits the transmission channel. Several techniques are used to try to minimize these effects. It should be noted that more than one processor may be used for processing at the surface.

### Pump Noise Cancellation (PNC)

In one embodiment, the PNC technique utilizes pump strobe signals from each active pump. In concept at least, this technique is relatively easy to describe. The signature for each pump is assembled by marking the time at which successive pump strobes occur, and stacking the pressure records between the strobes. This results in random noise being cancelled out, and the pump signature emerges. This pump signature is then subtracted from the raw pressure data; the result is the measured pressure signal with the signal from the pump cancelled out. In the ideal case, which occurs quite often, this resultant signal contains only the signal from pulser 19. For additional details, refer to U.S. Pat. No. 4,642,800, which is incorporated herein by reference.

Alternatively, the pump pressure signal may be analyzed directly to provide an indication of the pump signal frequency signature. This technique eliminates the need for pump strobe sensors. Further details of such a technique are disclosed in application docket number 564-39321-US and 564-42151-US, filed on the same day as this application and assigned to the assignee of this application, and which is incorporated herein by reference.

### Channel Equalization

Channel equalization is directed to removing any distortions of the waveforms that may have occurred during their transit through the telemetry channel. In one embodiment, an inference filter is used to estimate the response of the transmission channel. Basically, a model of the transfer function (also known as the frequency response function) of the telemetry channel is computed, see FIG. 13. The transfer function is nothing more than a description of the changes in amplitude and phase for each frequency bin that occur to a signal during its travel from downhole to surface. The technique estimates pressure and/or flow at downhole pulser using the measured pressure and flow at surface and the detailed description of the mud line between the pulser and the sensors (pressure sensor and flow meter).

For the model to simulate data transmission through the mud channel the transfer matrix method is used. Derived from partial differential equations describing the wave propagation with the states of pressure and flow, transfer matrices are calculated for the different system components. Here, the different components are pipes (BHA, drillpipe, Kelly hose, etc)

$${T}_{pipe} = [ \begin{matrix}cosh ( γ l ) & - {Z}_{c} ρ g sinh ( γ l ) \\ \frac{1}{{Z}_{c} ρ g} sinh ( γ l ) & cosh ( γ l )\end{matrix} ] \qquad ( 7 )$$

### With γ²=Cs(Ls+R) where L=1/gA is the inertance, C=gA/a² is the capacitance, A=πID² the inner cross section area, s=σ+iω, and R the linearized resistance per unit length dependent on the flow in the tube.

Using these transfer matrices for each drillstring component it is possible to connect the pressure and flow states of an upstream and downstream end (the surface and downhole locations). For drill strings with different sections the matrices have to be multiplied from left coming uphole. That is,

$${[ \begin{matrix}p \\ q\end{matrix} ]}_{sensor} = {\underbrace{{T}_{pipe 4} {T}_{pipe 3} {T}_{pipe 2} {T}_{pipe 1}}_{T} [ \begin{matrix}p \\ q\end{matrix} ]}_{pulser} . \qquad ( 8 )$$

Arbitrary combinations of pipe sections are possible and described in a file containing the drill string description. For the reconstruction of the pulser pressure we use the inverse transfer matrices with zeros at the frequencies of possible poles:

$${[ \begin{matrix}p \\ q\end{matrix} ]}_{pulser} = {\underbrace{{T}^{- 1}}_{{T}_{inv}} [ \begin{matrix}p \\ q\end{matrix} ]}_{sensor} \qquad ( 9 )$$

The first row for the calculation reads:

pₚᵤₗₛₑᵣ=T_{inv1,1}·pₛₑₙₛₒᵣ+T_{inv1,2}·qₛₑₙₛₒᵣ (10)

This last equation describes the inference filter in the frequency domain as disclosed in U.S. patent application Ser. No. 10/412,915 of Jogi et al. and assigned to the assignee of this application, and which are incorporated herein by reference. In the time domain the output of the inference filter is given by convolving the measured pressure and flow signals with the inverse Fourier transform respectively of T_{inv1,1} and T_{inv1,2}. The calculation of the filter coefficients is done in surface controller 24 (see FIG. 1) or any other suitable processing device at the surface., and updated with the new coefficients. This calculation is performed at every change in the drill string and/or mud line between pulser and surface sensors (when adding a new joint of pipe, changing BHAs, and so on). Additional details on channel equalization are contained in U.S. applications filed under docket number 564-42779 and 564-43121, filed on the same day as this application and assigned to the assignee of this application, and which are incorporated herein by reference. The determination of the channel transfer function may be done using a reference chirp signal as described in U.S. patent application Ser. No. 11/284,319 of Hentati et al. assigned to the assignee of this application, and which are incorporated herein by reference.

In addition to channel equalization and pump noise cancellation, other techniques are used to enhance the reliability of the data transfer. These include Channel Estimation described in U.S. application Ser. Nos. 11/311,196 and 11/018,344 and assigned to the assignee of this application, and which are incorporated herein by reference.

### Synchronization

In order to demodulate 47 and decode 48 the received data, it is necessary for the surface system to synchronize on the data stream. As described previously, in one embodiment, the data is transmitted in a known pattern having a bitperiod, Tbit. To decipher the incoming data stream, the surface controller 24 must identify the start of the bit pattern so that the bit value, 1 or 0, in each bit period can be determined. Synchronization on the data stream is achieved through the use of pulse synchronization markers 601, which typically are embedded in the pulse stream when the pulser starts-up and periodically within the ongoing data stream, and frame identifiers (FIDs) 602 which occur periodically within the bit stream, see FIG. 8. The FIDs 602 are of a fixed length, and delineate the start of a frame of data. Within a frame the data bits 603 fall within words in a format that is known to both the downhole transmitter and surface receiver. The synchronization markers 601 are inserted in the data stream during the downhole encoding 41.

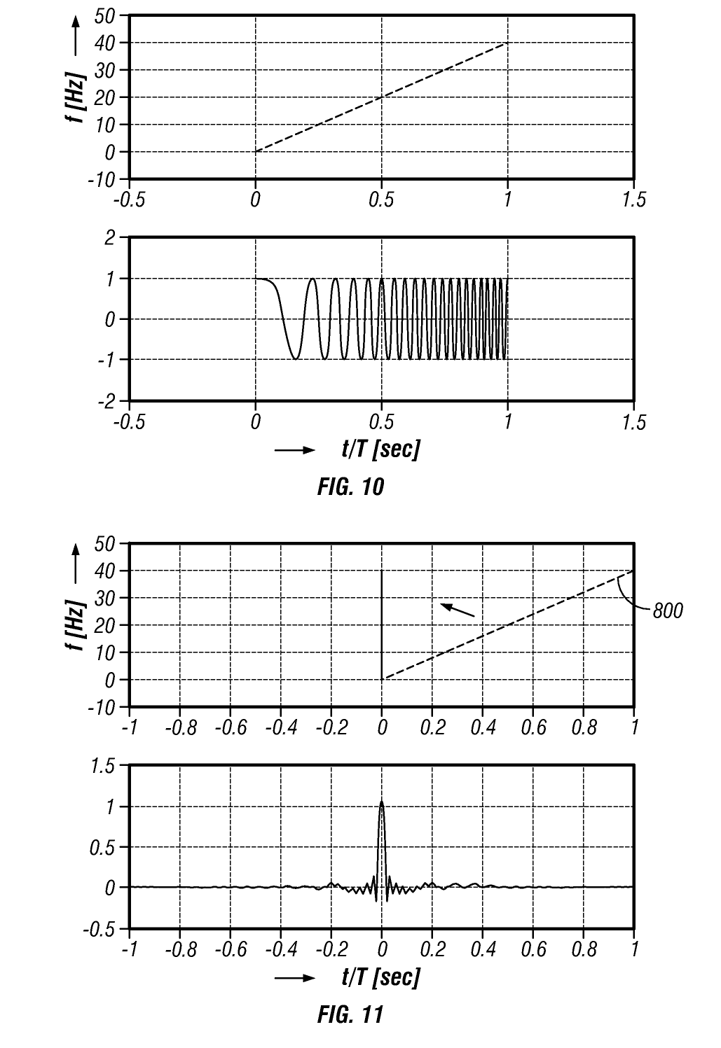

In one embodiment, the synchronization marker comprises one or more chirp signals and a preamble, see FIG. 9. The chirp signal, see FIG. 10, is a linear, frequency modulated pulse. At the beginning of the pulse (time=0 sec) the frequency is f₀ and rises to f_{end}>f₀ at pulse end. FIG. 10 shows the chirp pulse in the time domain (lower figure) and its frequency over time (upper figure). The frequency rises over the pulse time width T from 0 Hz to 40 Hz. The exemplary chirp pulse has then a bandwidth of 40 Hz.

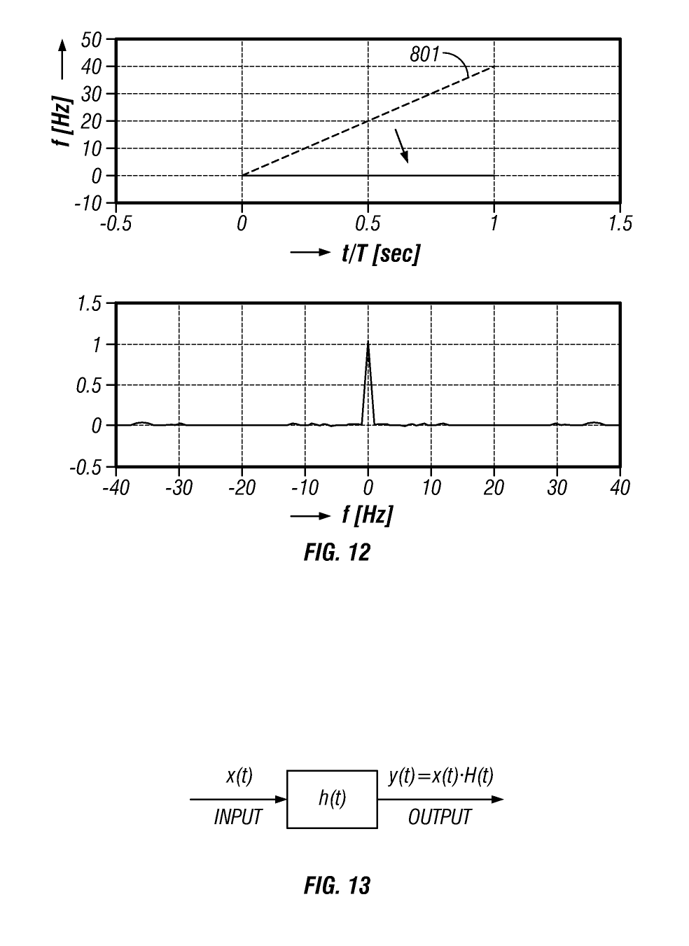

Chirps have the important characteristic of being compressible in the time domain as well as in the frequency domain. Chirp-compression is done by the correlation operation. The autocorrelation of a chirp results in a very sharp and high amplitude pulse. The same operation in the frequency domain gives a high peak at frequency 0 Hz. The autocorrelation function gathers (compresses) most of the energy of the chirp pulse at one point. FIG. 11 shows the autocorrelation of the chirp pulse in time domain and in frequency domain. Chirp-compression means a projection of the linear frequency curve 800, 801 on to the vertical axis in case of time domain correlation, and on to the horizontal axis in case of frequency domain correlation, see FIGS. 11 and 12 respectively.

As shown above, chirp-compression generates sharp pulses with high peaks. The peak width is equal to 2/chirp bandwidth. The amplitude of the peak equals T (the chirp length). In FIG.S 11 and 12 the correlation function is normalized to the chirp pulse width T. The chirp can be detected when the amplitude of the correlation function of the signal with the reference chirp exceeds a given threshold. However, this method is very sensitive to noise, especially when the signal average changes over time. To overcome this problem the signal is split into overlapped blocks of length 2*N−1 (N is the length of a chirp) and each signal block is normalized by the mean value of its amplitude.

$$y ( i ) = \frac{x ( i )}{\frac{1}{2 N} {\sum }_{i = 1}^{2 N} \vert x ( i ) \vert} . \qquad ( 11 )$$

The number of overlapped samples affects the accuracy of detecting the chirps. Test well data have shown that using an overlap of (2*1024−1)−256 samples (shift by 256 samples) is enough.

The estimated chirp position is found from the maximum amplitude of the normalized signal blocks. The peak value of the L-th signal block is given by:

p_{L}(i)=max{|y(i)|} (12).

### If the peak value is higher than a given threshold (T-Threshold), then a chirp will be detected and its position will be output to the next step.

Due to the fact that the noise levels changes over time, the block wise measured peak values are averaged and the threshold (for detecting chirps) is set to 1.2 times the averaged value. The threshold S_{T} will be updated every time the peak value of a new signal block is calculated:

$${S}_{T} ( n ) = \frac{1}{n} {\sum }_{i = 1}^{n} {p}_{i} . \qquad ( 13 )$$

### In order to get reliable chirp detection, the estimated chirp positions will be checked by the following.

### Frequency Domain Chirp Compression

At this stage, the reference chirp is multiplied with a signal block that has the same length as the chirp and which begins at the chirp position estimated by the previous step. The resultant signal is transformed in the frequency domain by an FFT. Only a bandwidth of 40 Hz concentrated at 0 Hz is considered at this stage. This is not to be construed as a limitation to the invention.

### Correct for Chirp Position

When chirp pulse occurs, the frequency domain compression results in a high peak at frequency 0 Hz. Similar to the time domain peak detection, we normalize the FFT output to the mean value of its amplitude. If the amplitude at 0 Hz exceeds a given threshold S_{F} (F-Threshold, frequency domain threshold) then the chirp position estimated in step 1 will be assumed to be the correct position of a chirp; otherwise it will be considered a false alarm.

### Chirps Signaling

To mark the chirp pulse positions in the incoming signal, the chirp detection technique adds to the first sample of the chirp pulse an integer number with very high amplitude. This assures that the resulting peak is much higher than the highest MWD signal amplitude. These peaks will be detected in the decoding 48 step to keep synchronization.

In addition to the chirps discussed above, other sequences such as stepped frequency sine waves may be transmitted to aid in synchronization.

In one embodiment, for FSK, CPM and PSK modulated signals, a known multibit preamble, for example sixteen bits, is used to enhance fine synchronization. The use of multiple bits in a known sequence allows the surface system to more accurately determine the bit boundaries for eventual decoding of signals.

In one embodiment, chirp signals are embedded in the data stream at known points and the surface system locates and identifies these chirps to gain or maintain synchronization.

Once the surface controller is synchronized with the data stream, the signal is demodulated 47, decoded 48, decompressed 49 and output for storage and or further analysis.

While discussed above in relationship to data traveling from downhole to the surface, one skilled in the art will appreciate that a similar transmission scheme may be used for transmitting data from the surface to a downhole receiver. Such a system is described in U.S. application Ser. No. 10/422,440, filed on Apr. 24, 2003 and published as US 2004/0012500 on Jan. 22, 2004, previously incorporated herein by reference. It will be appreciated that such a downlink enables changes in the downhole system operation, and further enables a substantially automated telemetry system for adjusting transmission schemes to improve the reliability of information transfer.

The decompressed data may then be stored on a suitable medium for further processing and/or display. Such displays commonly include logs of the formation properties that are measured by the formation evaluation sensor, the operating conditions of the BHA, and borehole so information.

The operation of the transmitter and receivers may be controlled by the downhole processor and/or the surface processor. Implicit in the control and processing of the data is the use of a computer program on a suitable machine readable medium that enables the processor to perform the control and processing. The machine readable medium may include ROMs, EPROMs, EAROMs, Flash Memories and Optical disks.

The foregoing description is directed to particular embodiments of the present invention for the purpose of illustration and explanation. It will be apparent, however, to one skilled in the art that many modifications and changes to the embodiment set forth above are possible. It is intended that the following claims be interpreted to embrace all such modifications and changes.

What is claimed is:

1. A system for communicating data from a downhole location to a surface location, the system comprising:
(a) a bottomhole assembly (BHA) conveyed in a borehole in the earth formation;
(b) a signal source on the BHA, the signal source configured to produce a pulsed variation in a fluid in a borehole, the pulsed variation including a bitstream indicative of the data to be communicated;
(c) at least one sensor near a surface location in the borehole configured to produce a signal responsive to the pulsed variation; and
(d) at least one processor configured to:
(A) estimate from the signal the produced pulsed variation, and
(B) use the estimated pulsed variation to estimate the data.

2. The system of claim 1 wherein the data to be communicated is indicative of an output of a formation evaluation (FE) sensor on the BHA.

3. The system of claim 1 wherein the data to be communicated is indicative of an operating condition of the BHA, the system further comprising a sensor configured to make a measurement about the operating condition.

4. The system of claim 1 wherein the data to be communicated is survey information about the borehole, the system further comprising a surveying device configured to produce the survey information.

5. The system of claim 1 wherein the signal source is selected from the group consisting of: (i) an oscillating valve, (ii) a poppet type pulser, and (iii) a siren.

6. The system of claim 1 wherein the pulsed variation further comprises at least one of: (i) a pressure pulse, and (ii) a flow rate pulse.

7. The system of claim 1 wherein the bitstream further comprises a synchronization marker and wherein the processor is further configured to use the synchronization marker in processing of the signal.

8. The system of claim 1 wherein the pulsed variation further comprises a modulation selected from: (i) a pulse amplitude modulation, (ii) frequency shift keying, (iii) amplitude shift keying, (iv) phase shift keying and (v) continuous phase moderation.

9. The system of claim 1 wherein the sensor comprises at least one of: (i) a pressure sensor, and (ii) a flow rate sensor.

10. The system of claim 1 wherein the at least one processor is further configured to do at least one of: (i) removing noise components, and (ii) perform a channel equalization.

11. The system of claim 1 further comprising a downhole processor configured to perform a data compression operation to the data.

12. The system of claim 1 wherein the at least one processor is further configured to perform a decompression.

13. The system of claim 1 wherein the sensor at the surface location further comprises at least two longitudinally-spaced transducers.

14. The systems of claim 7 wherein the synchronization marker further comprises at least one chirp signal.

15. The system of claim 7 wherein the synchronization marker further comprises a plurality of chirp signals embedded at known points.

16. A method of communicating data from a downhole location to a surface location, the method comprising:
(a) conveying a bottomhole assembly (BHA) conveyed in a borehole in the earth formation;
(b) activating a signal source on the BHA to produce a pulsed variation in a fluid in a borehole, the pulsed variation including a bitstream indicative of the data to be communicated;
(c) using at least one sensor near a surface location in the borehole to produce a signal responsive to the pulsed variation;
(d) estimating from the signal the produced pulsed variation, and
(e) using the estimated pulsed variation to estimate the data.

17. The method of claim 1 wherein the data to be communicated is indicative of at least one of: (i) a property of the earth formation, (ii) operating condition of the BHA, and (iii) survey information about the borehole.

18. The method of claim 16 wherein producing the pulsed variation further comprises producing at least one of: (i) a pressure pulse, and (ii) a flow rate pulse.

19. The method of claim 16 further comprising using a synchronization marker in the bitstream, the method further comprising using the synchronization marker in processing of the signal.

20. The method of claim 16 wherein producing the pulsed variation further comprises performing a modulation encoding at least one of: (i) a pulse amplitude modulation, (ii) frequency shift keying, (iii) amplitude shift keying, (iv) phase shift keying and (v) continuous phase moderation.

21. The method of claim 16 wherein using the sensor further comprises using at least one of: (i) a pressure sensor, and (ii) a flow rate sensor.

22. The method of claim 16 further comprising at least one of: (i) removing noise components, and (ii) perform a channel equalization.

23. The method of claim 16 further comprising performing a data compression operation prior to the signal source producing the pulsed variation.

24. The method of claim 16 further comprising performing a decompression at the surface location.

25. The method of claim 16 wherein using the sensor at the surface location further comprises using at least two longitudinally-spaced transducers.

26. The method of claim 19 wherein the synchronization marker further comprises a plurality of chirp signals embedded at known points.

27. A computer-readable medium for use with a system for communicating data from a downhole location to a surface location, the system comprising:
(a) a bottomhole assembly (BHA) conveyed in a borehole in the earth formation;
(b) a signal source on the BHA, the signal source configured to produce a pulsed variation in a fluid in a borehole, the pulsed variation including a bitstream indicative the data to be communicated; and
(c) a sensor near a surface location in the borehole configured to produce a signal responsive to the pulsed variation;
the medium comprising instructions which enable a processor to:
(d) estimate from the signal the produced pulsed variation, and
(e) use the estimated pulsed variation to estimate the data.

28. The medium of claim 27 further comprising at least one of: (i) a ROM, (ii) an EPROM, (iii) an EAROM, (iv) a flash memory, and (v) an optical disk.
